(19) United States
(12) Patent Application Publication
(10) Pub. No.: US 2009/0037493 A1
(43) Pub. Date: Feb. 5, 2009

(54) METHOD AND DEVICE FOR UPDATING AN OBJECT WITH COPYRIGHT ATTRIBUTE

(75) Inventors: Pei DANG, Shenzhen (CN); Yimin LI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/211,356

(22) Filed: Sep. 16, 2008

Related U.S. Application Data
(63) Continuation of application No. PCT/CN2007/001561, filed on May 15, 2007.

(30) Foreign Application Priority Data
Mar. 16, 2006 (CN) 200610057597.9

(51) Int. Cl. G06F 17/30

(52) U.S. Cl. 707/201; 707/E17.01

(57) ABSTRACT

The present invention discloses a method for updating an object with copyright attribute, thereby solving the problem of the prior art that a terminal equipment (TE) can still consume the original Media Object (MO) after a MO is updated. The method comprises: obtaining a MO which is changed from a server, and obtaining a corresponding new Copyright Object (RO) from a Copyright Issuance (RI) server, by a TE; and installing the changed MO and deleting the original MO and the original RO corresponding to the original MO by the TE. At the same time, the invention further discloses a TE.

### CROSS-REFERENCE TO RELATED APPLICATION

This application is a continuation of International Patent Application No. PCT/CN2007/001561, filed May 15, 2007, which claims priority to Chinese Patent Application No. 200610057597.9, filed Mar. 16, 2006, each of which is hereby incorporated by reference in its entirety.

### FIELD OF THE INVENTION

The present invention relates to digital copyright management technology in the field of wireless communications, and in particular, to a method and device for updating an object with copyright attribute.

### BACKGROUND OF THE INVENTION

With the development of wireless networks, download services of mobile terminals become more and more abundant, and download functions also become increasingly stronger. At present, in consideration of the support of digital content right protection and good user experience, there appears a download method which embeds information related to Copyright Object (RO) in a Download Descriptor (DD); that is, specific information of a RO related to the Media Object (MO, or referred to as media content or content) to be downloaded may be described in a DD, and after a terminal receives the DD, it may obtain the RO from the information related to the RO in the DD; thereby it may be guaranteed that the user may correctly use the content downloaded. By this method, the download of the media content and the download of the corresponding RO may be accomplished in one download process, so that it may be convenient for the user to use the content. Because the MO and the corresponding copyright may be downloaded together in one download process, then when the user updates the MO; if the RO of the updated MO is different from the RO of the original MO, the updated MO and the new RO will be downloaded together to the terminal.

At present, a process for updating a MO carrying related copyright information (the media content has a copyright which only belongs to itself) is as shown in FIG. 1, which mainly includes:

100: A MO and its corresponding RO (the RO only corresponds to the MO) have been successfully downloaded and installed in a user terminal.

The user requests to update the MO, and the terminal requests the latest Download Descriptor DD′ of the content according to the update request URI address corresponding to the MO in the DD.

101: A download server sends the latest Download Descriptor DD′ to the terminal.

102: For this example, the MO is updated and the RO corresponding to the updated MO′ is also changed. In this example, the RO corresponding to the updated MO′ is RO′, thus the DD′ includes information of MO′ and information related to the corresponding RO′.

The terminal compares the information corresponding to the MO (such as ObjectID and ObjectVersion) in the DD with that in the DD′ so as to determine whether the MO to be updated is changed.

103: The terminal confirms that the MO is updated, thus it requests the user to confirm the update.

104: The user confirms that the MO is updated.

105 and 106: A terminal download agent requests the latest MO′ from the download server and obtains the latest MO′.

107: The terminal download agent sends RO obtaining information to a digital copyright management (DRM) agent.

108 and 109: The terminal DRM agent requests the RO′ corresponding to the MO′ from a Copyright Issuance (RI) server and obtains the RO′.

110: The terminal DRM agent returns the copyright obtaining result to the download agent.

111: The terminal installs the MO′ and deletes the original MO after the MO′ is installed successfully.

112: The terminal sends an installation success report to the download server.

At present, a process for updating a plurality of MOs sharing a RO is as shown in FIG. 2:

200: MO1, MO2 and their common RO (the download information of MO1 and MO2 is described in one DD) have been successfully downloaded and installed in a user terminal.

The user requests to update MO1, and a terminal download agent requests the latest Download Descriptor DD′ of the content according to the update request URI address in the DD.

201: A download server sends the latest DD′ to the terminal.

202: For this example, because MO1 and MO2 are both updated and the RO shared by them is also updated; therefore DD′ includes information of MO1′ and MO2′, and information related to the corresponding RO′.

The terminal download agent compares the information corresponding to each MO in the DD with that in the DD′ so as to determine whether each MO is changed.

203: The terminal download agent confirms that MO1 and MO2 are updated; therefore it requires the user to select an MO to be updated in the content updated.

204: The user confirms that only MO1 is to be updated.

205: The terminal download agent sends RO obtaining information to a DRM agent.

206 and 207: The terminal DRM agent requests the RO′ corresponding to MO1′ from a RI server and obtains the RO′.

208: The terminal DRM agent returns the copyright obtaining result to the download agent.

209 and 210: The terminal download agent requests the latest MO1′ from the download server and obtains the latest MO1′.

211: The terminal installs the MO1′ and deletes the original MO1 after the MO1′ is installed successfully.

212: The terminal sends an installation success report to the download server.

For the above solution, when updates a MO carrying related copyright information in a DD, a user only deletes the old MO after the MO is updated successfully while the RO corresponding to the original MO is not deleted; since the original RO is not deleted, the user may obtain the original MO by super distribution or other methods. As a result, the original MO still can be consumed in the terminal after the original MO is updated successfully; consequently, the principle of update is violated.

Next, for the case that one copyright object is shared by a plurality of MOs, because an existing method allows to update a single MO, as a result, a new copyright object corresponding to the updated version of the plurality of MOs is also updated at the same time when the single MO is updated. Therefore, the user may obtain the updated version of other MOs by super distribution or other methods without updating the other MOs in the terminal, so that the updated version of other MOs may be consumed at the terminal, thereby lowering the control force of the RO on the content consumption.

### SUMMARY OF THE INVENTION

One embodiment of the invention provides a method and device for updating an object with copyright attribute, thereby solving the problem of the prior art that an original MO still can be consumed after the MO is updated.

Moreover, the problem of the prior art may be solved that when a plurality of MOs share a RO, and the consumption of other updated MOs may be obtained by other methods after a MO is updated.

A method for updating an object with copyright attribute, including the following steps:

obtaining a MO which is changed from a server, and obtaining a corresponding new RO from a RI server, by a Terminal Equipment (TE); and installing the changed MO and deleting the original MO and the original RO corresponding to original MO, by the TE.

A method for updating an object with copyright attribute, including the following steps: determining that a plurality of MOs sharing one RO are changed and requiring to update all the changed MOs when updating one of the original MO, by a TE; obtaining a new RO from a RI server and obtaining all the changed MOs from the server, by the TE; and installing all the changed MOs and deleting the original MOs, by the TE.

A TE includes: a module, configured to obtain a changed MO from a server and obtain a new RO corresponding to the changed MO from a RI server; and a module, configured to install the changed MO and delete the original MO and original RO.

Moreover, the TE further includes a module configured to merge the original Copyright Object and the new Copyright Object or to return the original Copyright Object, before deleting the original Copyright Object.

A TE, including: a module, configured to determine that a plurality of MOs sharing one RO are changed and require to update all the changed MOs when updating one of original MOs; a module, configured to obtain a new RO from a RI server and obtain all the changed MOs from a server; and a module, configured to install all the changed MOs and delete the original MOs.

Moreover, the TE may further includes a module configured to delete the original Copyright Object shared by the plurality of Media Objects.

Moreover, the TE may further includes a module configured merge the original Copyright Object and the new Copyright Object or return the original Copyright Object before deleting the original Copyright Object.

In the embodiments of the invention, after a TE updates a MO, it not only deletes the original MO, but also deletes the RO corresponding to the original MO, so that after a user successfully updates the media content, the user is unable to use the original media content; for the case that a plurality of media contents share a RO, the user is forced to update all the updated media contents at one time and no other selections can be made by the user, so that it can be guaranteed that the user can only use the new media content after updating the media content. Therefore, the control force of the RO on consumption of media content is improved.

### BRIEF DESCRIPTION OF THE DRAWINGS

FIG. 1 is a flow chart of a process for updating a MO in the conventional art;

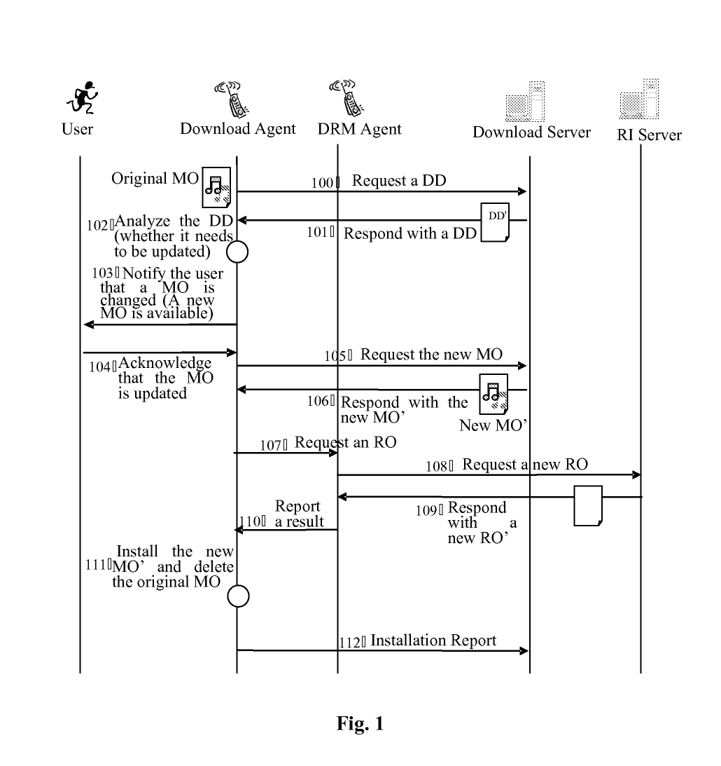

FIG. 2 is a flow chart of a process for updating MOs that share a RO in the conventional art;

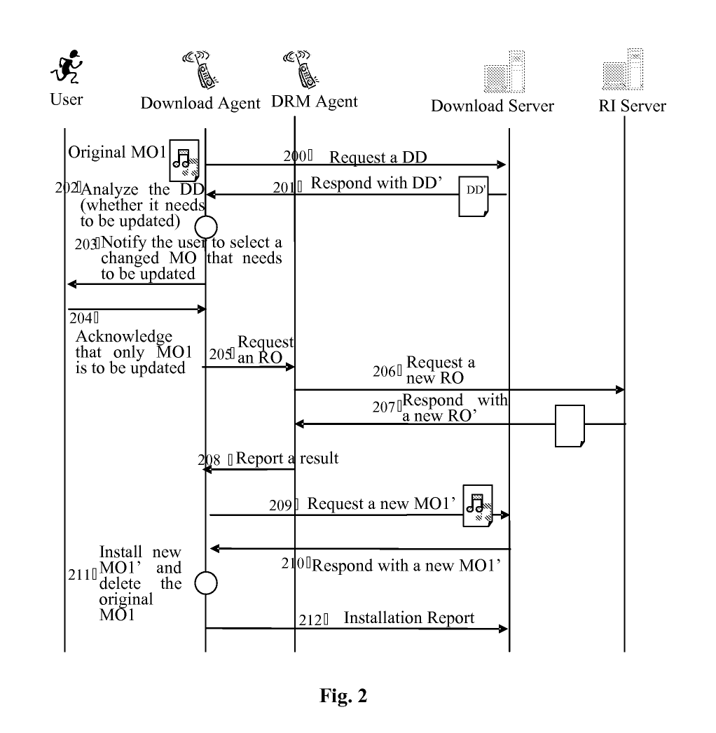

FIG. 3 is a structure schematic diagram of a terminal equipment according to an embodiment of the invention;

FIG. 4 is a flow chart of a process for updating a MO according to an embodiment of the invention;

FIG. 5 is a flow chart of a process for updating a MO according to another embodiment of the invention;

FIG. 6 is a flow chart of a process for determining that a plurality of MOs share an RO according to another embodiment of the invention; and

FIG. 7 is a flow chart of a process in which a user cancels an update of a MO according to another embodiment of the invention.

### DETAILED DESCRIPTION OF THE EMBODIMENTS

In the embodiments of the invention, the method for updating an object carrying copyright information in a Download Descriptor DD is reinforced, so that after a user successfully updates the media content, the user is unable to use the old media content. Moreover, for the case that a plurality of media contents share a RO, the user is forced to update all the updated media contents at one time and no other selections can be made by the user, so that it can be guaranteed that the user can only use the new media content after updating the media content. As a result, the normal update may be guaranteed.

### Embodiment 1

This embodiment will be illustrated by, for example, updating a MO with its own related copyright information.

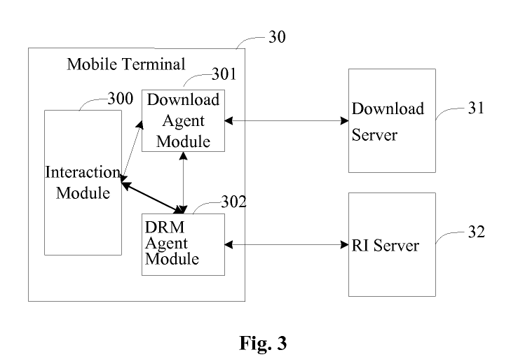

Referring to FIG. 3, TE 30 includes an interaction module 300, a download agent module 301 and a DRM agent module 302. The interaction module 300 is adapted to output information to a user and receive information input by the user; the download agent module 301 is adapted to communicate with the download server 31, download a DD and a MO from a download server 31, determine whether the MO is changed according to the DD, install and delete the MO, etc.; the DRM agent module 302 is adapted to communicate with a RI server 32 and perform a process related to copyright, such as applying the RO and deteleting the RO.

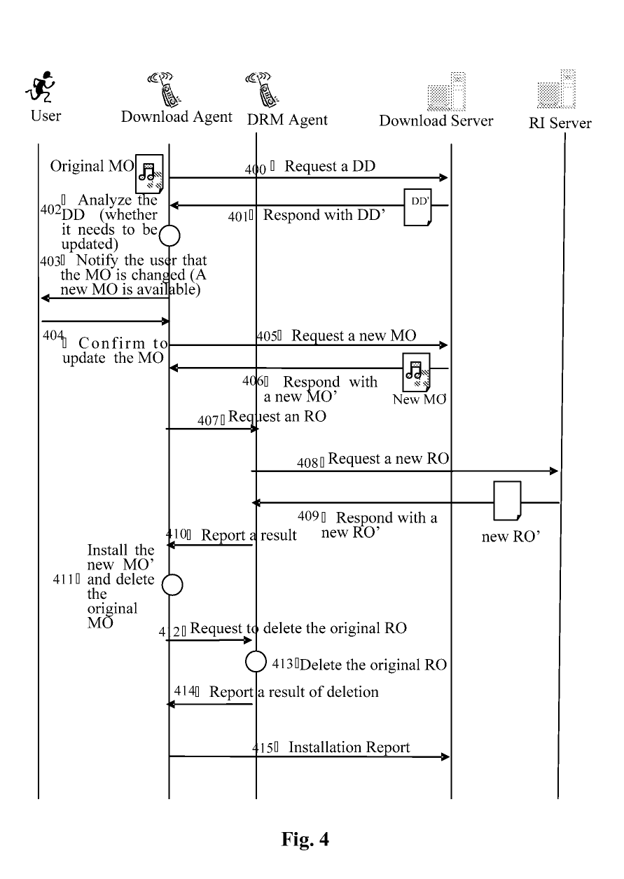

Referring to FIG. 4, in the embodiment, a process in which a TE updates a MO is as follows:

Step 400: A MO and its corresponding RO (which only corresponds to the MO) have been downloaded successfully and installed in a user terminal. The user requests to update the MO, and the download agent module in the TE requests the latest Download Descriptor DD′ of the content from a download server according to the update request URI address corresponding to the MO in the DD.

Step 401: A download server sends the latest Download Descriptor DD′ to the terminal.

Step 402: The MO is updated and the RO corresponding to the updated Media Object MO′ is also changed, and the RO corresponding to the MO′ is RO′; therefore DD′ includes information of MO′ and information of the corresponding RO′. The download agent module compares the information corresponding to the MO (such as ObjectID and ObjectVersion) in the DD with that in the DD′ so as to determine whether the MO to be updated is changed.

Step 403: The terminal confirms that the MO is updated, thus the user is requested to confirm the update via the interaction module.

Step 404: The user confirms to update the MO.

Steps 405-406: The download agent module requests the latest Media Object MO′ from the download server, and the download server returns the MO′ to the download agent module of the terminal.

Step 407: The download agent module sends RO obtaining information to a DRM agent module.

Steps 408-409: The DRM agent module requests the Copyright Object RO′ corresponding to the MO′ from an RI server, and the RI server returns the RO′.

Step 410: The DRM agent module reports a copyright obtaining result to the download agent module.

Step 411: The download agent module controls the installation of the MO′ and deletes the original MO after the MO′ is installed successfully.

Step 412: The download agent module requests the DRM agent module to delete the original RO.

Step 413: The DRM agent module in the terminal deletes the original RO.

Step 414: The DRM agent module reports a result of copyright deletion to the download agent module.

Step 415: The download agent module in the terminal sends an installation success report to the download server.

In the above process, the deletion of the original RO may also be performed after the new Copyright Object RO′ is successfully obtained in Steps 408-409. The download agent module requests to delete the original RO immediately after a the RO′ is obtained successfully.

To further guarantee the control of the RO on the consumption of media content, for a RO with a state (the TE may determine whether there exists information of a state according to the description information in the RO using an existing method), before deletion, the DRM agent module merges the state information in the original RO and the new RO, thus it may be guaranteed that the new RO control the user to consume the updated MO by referring to the state information of the original RO. For example, there is a restriction by the original RO that the user can only use the MO for ten times; if the user has used the MO for five times, the user still can use the MO for 5 times. In the new RO, there is still a restriction that the user can use the MO for 10 times. At this point, the DRM agent module may modify the restriction on times of use in the new RO to 5.

The merge of ROs may also be performed on a RI server. When the TE requests a new RO from the RI server; if the RI server finds that the RO is a RO with a state, it requires the TE to provide the original RO; then, the server sends the new RO to the TE after modifying the state information of the new RO according to the state information of the original RO.

For a RO with a state, a copyright return process may also be performed to the RI server before deletion; in other words, the TE submits the original copyright to the RI server, and the RI server carries out a refund process.

The RO merge or return process may be selected by the DRM agent module in the TE, or by a user prompted through an interaction module. For all processes of the RO, such as direct deletion, local merge by a DRM agent, remote merge by a RI server, return, DRM agent selection and user selection, etc., may be indicated in the DD, and the TE selects the corresponding processing mode according to the indication.

The operation and function accomplished by the download agent module and the DRM agent module in the embodiment may be disassembled and accomplished by a plurality of corresponding functional modules. For example, MO installation may be accomplished by another installation module, and MO deletion may be accomplished by another deletion module, etc. They are the same in essence, so such a modification will not influence the implementation of the invention.

### Embodiment 2

This embodiment is illustrated by taking a process for updating a plurality of MOs sharing a RO as an example.

Referring to FIG. 3, TE 30 includes a interaction module 300, a download agent module 301, and a DRM agent module 302. The interaction module 300 is adapted to output information to a user and receive the information input by the user; the download agent module 301 is adapted to communicate with download server 31, download a DD and a MO from download server 31, determine whether a plurality of MO on the current equipment share the same one RO and whether the plurality of MOs are changed, and install and delete a MO, etc.; the DRM agent module 302 is adapted to communicate with RI server 32 and perform a process related to copyright, such as applying the RO and deleting the RO.

The operation and function accomplished by the download agent module and the DRM agent module in this embodiment may be disassembled and accomplished by a plurality of corresponding functional modules. They are same in essence; therefore such a modification will not influence the implementation of the invention.

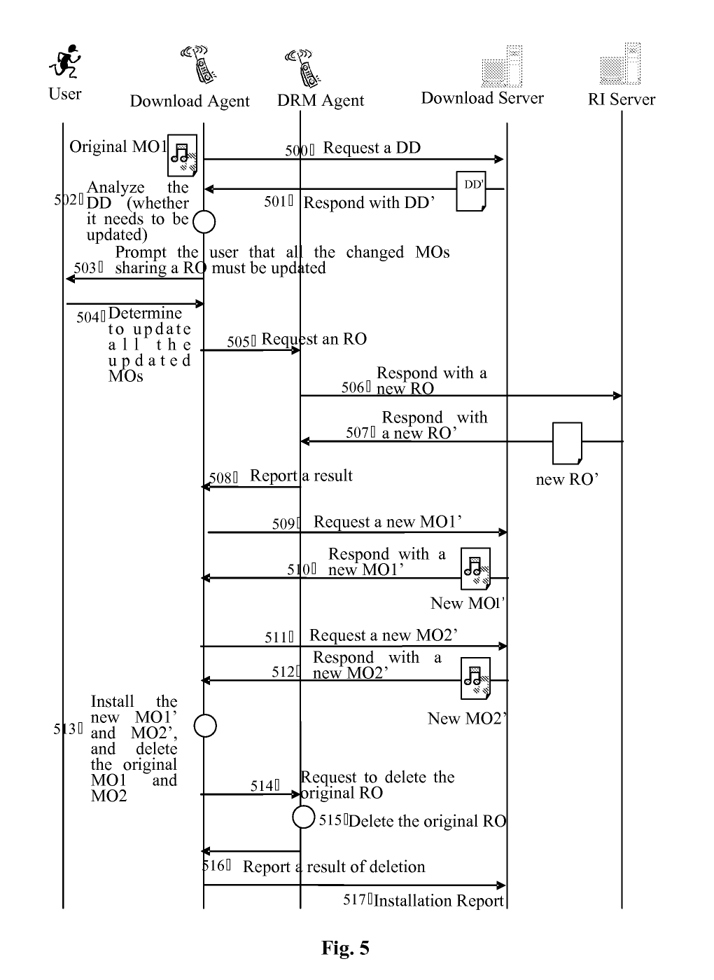

Referring to FIG. 5, in this embodiment, the process in which a TE updates a MO is as follows:

Step 500: Media Object MO1, MO2 and their common Copyright Object RO (the download information of MO1 and MO2 is described in a DD) have been successfully downloaded and installed in a user terminal (for specific DD information, reference may be made to the Background of the Invention). The user requests to update MO1, and a download agent module in the TE requests the latest Download Descriptor DD′ of the content from a download server according to the update request URI address in the DD.

Step 501: A download server sends the latest Download Descriptor DD′ to the terminal.

Step 502: In this example, because MO1 and MO2 are both updated and the RO shared by them is also updated; therefore DD′ includes information of MO1′, MO2′ and information related to the corresponding Copyright Object RO′ (for specific information of DD′, please make reference to the Background of the Invention).

The download agent module in the terminal compares the information corresponding to each MO in the DD with that in the DD′ so as to determine whether each MO is changed. Moreover, the terminal further needs to determine whether the MO which the user requests to update shares a RO with other MOs.

Step 503: The terminal download agent confirms that MO1 and MO2 are updated and they share the same one RO. Therefore, the interaction module prompts the user to update all the updated MOs sharing one RO.

Step 504: The user confirms to update all the updated MOs.

Step 505: The terminal download agent sends RO obtaining information to a DRM agent module.

Steps 506-507: The DRM agent module of the terminal requests a new Copyright Object RO′ from a RI server, and the RI server returns the RO′.

Step 508: The DRM agent module of the terminal reports a copyright obtaining result to the download agent.

Steps 509-510: The download agent module of the terminal requests the latest Media Object MO1′ from the download server, and the download server returns the MO1′.

Steps 511-512: The DRM agent module of the terminal requests the latest Media Object MO2′ from the download server, and the download server returns the MO2′.

Step 513: The download agent module of the terminal installs the MO1′ and MO2′, and the original Media Object MO1 and MO2 need to be deleted after the MO1′ and MO2′ are installed successfully.

Step 514: The download agent module of the terminal requests the DRM agent module to delete the original RO.

Step 515: The DRM agent module of the terminal deletes the original RO.

Step 516: The DRM agent module of the terminal reports a copyright deletion result to the download agent module.

Step 517: The download agent module of the terminal sends an installation success report to the download server.

In the above process, the deletion of the original RO may also be carried out after the new Copyright Object RO′ is obtained successfully in Step 506-507.

Similarly, to further guarantee the control of the RO on consumption of media content, for a RO with a state (the TE may determine whether there exists a state according to the description information in the RO using an existing method), before deletion, the DRM agent module may further perform a RO merge or return process. The specific implementation is the same as that in Embodiment 1, so it will not be described again here.

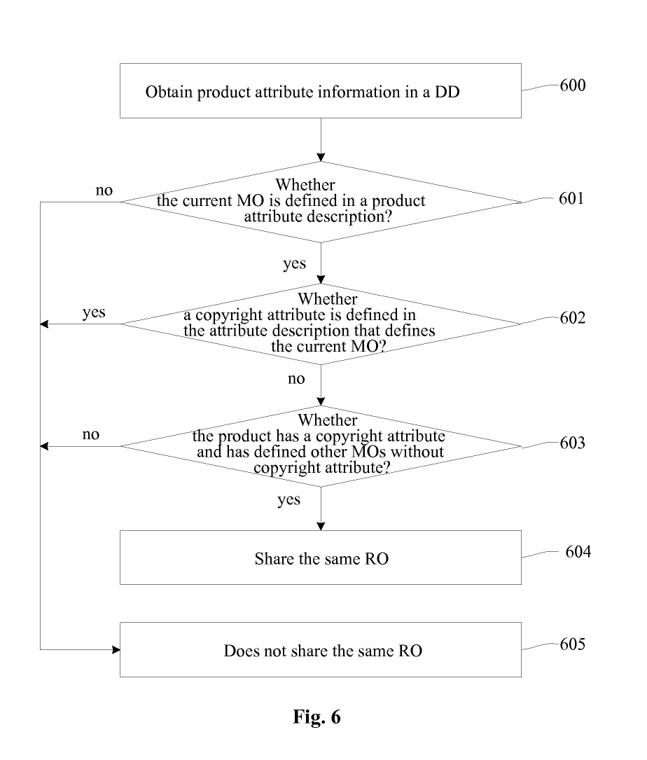

Referring to FIG. 6, a process in which a terminal determines whether the current MO shares one RO with other MOs is shown as follows (for the description information of DD, reference may be made to the Background of the Invention):

Step 600: The product attribute information in a DD is obtained.

Step 601: All product attribute descriptions are traversed, it is determined whether the current MO is defined in a product attribute description; if yes, then perform Step 602; otherwise, perform Step 605.

Step 602: It is determined whether a copyright attribute is defined in the attribute description that defines the current MO; if yes, then perform Step 605; otherwise, perform Step 603.

Step 603: It is determined whether the product defining the current MO has a copyright attribute and defines other MOs without copyright attribute; if yes, then perform Step 604; otherwise, perform Step 605.

Step 604: It is determined that the current MO shares the same one RO with other MOs defined in the DD, and the process ends.

Step 605: It is determined that the current MO does not share the same one RO with other MOs defined in the DD, and the process ends.

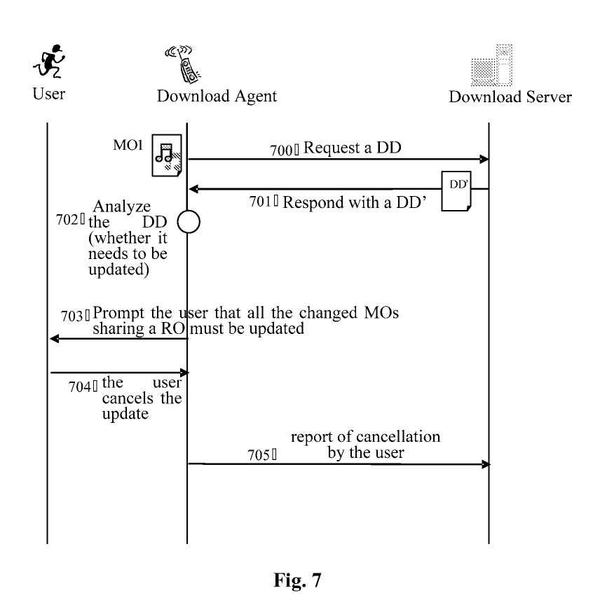

Referring to FIG. 7, a specific process that a user cancels an update is as follows:

Step 700: Media Object MO1, MO2 and their common RO (the download information of MO1 and MO2 is described in a DD) have been successfully downloaded and installed in a user terminal (for specific DD information, please make reference to the Background of the Invention). The user requests to update MO1, and a download agent module in the TE requests the latest Download Descriptor DD′ of the content from a download server according to the update request URI address in the DD.

Step 701: A download server sends the latest Download Descriptor DD′ to the terminal.

Step 702: In this example, because MO1 and MO2 are both updated and the RO shared by them is also updated; therefore DD′ includes information of MO1′, MO2′ and information related to the corresponding RO′ (for specific DD′ information, please make reference to the Background of the Invention).

The download agent module in the terminal compares the information corresponding to each MO in the DD with that in the DD′ so as to determine whether each MO is changed. Moreover, the download agent module of the terminal further needs to determine whether the MO which the user requests to update shares one RO with other MOs.

Step 703: The download agent module of the terminal confirms that MO1 and MO2 are updated and they share the same RO. Therefore, the user is prompted by the interaction module to update all the updated MOs sharing one RO.

Step 704: The user cancels the update.

Step 705: The download agent module sends an error state report, which indicates that the user cancels the update, to the server.

By the above technical solutions, after a user successfully updates the media content, the user becomes unable to use the old media content; and for the case that a plurality of media contents share one RO, the user is forced to update all the updated media contents at one time and no other selections can be made by the user. Therefore, it can be guaranteed that the user can only user the new media content after updating the media content, and the control force of the RO on consumption of media content can be improved. Obviously, those skilled in the art can make modifications and changes to the present invention without departure from the sprit and scope of the present invention. Therefore, in the event that these modifications and changes of the invention fall into the scope defined by claims of the present invention or its equivalents, then the present invention intends to cover these modifications and changes.

What is claimed is:

1. A method for updating an object with copyright attribute, comprising:
obtaining a Media Object which is changed from a server, and obtaining a corresponding new Copyright Object from a Copyright Issuance server, by a terminal equipment; and
installing the changed Media Object and deleting the original Media Object and the original Copyright Object corresponding to original Media Object, by the terminal equipment.

2. The method according to claim 1, wherein the Media Object is a Media Object with an independent copyright attribute.

3. The method according to claim 1, wherein the changed Media Object is a plurality of Media Objects sharing one Copyright Object, and the terminal equipment downloads and installs all the changed Media Objects.

4. The method according to claim 3, further comprising:
prompting a user to confirm whether to update all the changed Media Objects sharing one Copyright Object by the terminal equipment.

5. The method according to claim 1, further comprising:
deleting the original Copyright Object after the terminal equipment obtains the new Copyright Object, or after the terminal equipment successfully installs the changed Media Object.

6. The method according to claim 1, wherein the new Copyright Object and the original Copyright Object are Copyright Objects with a state, the method further comprising:
merging the new Copyright Object and the original Copyright Object before deleting the original Copyright Object; or,
returning the original Copyright Object to the Copyright Issuance server before deleting the original Copyright Object.

7. The method according to claim 6, further comprising:
merging the new Copyright Object and the original Copyright Object by the terminal equipment or by the Copyright Issuance server after the terminal equipment submits the original Copyright Objects to the Copyright Issuance server, and sending the merged Copyright Object to the Terminal Equipment by the Copyright Issuance server.

8. A method for updating an object with copyright attribute, comprising:
determining that a plurality of Media Objects sharing one Copyright Object is changed and requiring to update all the changed Media Objects when updating one of the original Media Objects by a terminal equipment;
obtaining a new Copyright Object from a Copyright Issuance server and obtaining all the changed Media Objects from the server, by the terminal equipment; and
installing all the changed Media Objects and deleting the original Media Objects by the terminal equipment.

9. The method according to claim 8, further comprising:
prompting a user to update all the changed Media Objects sharing one Copyright Object by the terminal equipment.

10. The method according to claim 8, further comprising:
deleting the original Copyright Object corresponding to the plurality of original Media Objects by the terminal equipment.

11. The method according to claim 10, further comprising:
deleting the original Copyright Object after the terminal equipment obtains a new Copyright Object, or, after the terminal equipment successfully installs the updated Media Object.

12. The method according to claim 10, wherein the original Copyright Object and the new Copyright Object are with a state, the method further comprising:
merging the original Copyright Object and the new Copyright Object before deleting the original Copyright Object; or,
returning the original Copyright Object to the Copyright Issuance server before deleting the original Copyright Object.

13. The method according to claim 12, further comprising:
merging the new Copyright Object and the original Copyright Object by the terminal equipment or by the Copyright Issuance server after the terminal equipment submits the original Copyright Objects to the Copyright Issuance server, and sending the merged Copyright Object to the terminal equipment by the Copyright Issuance server.

14. A terminal equipment, comprising:
a module, configured to obtain a changed Media Object from a server and obtain a new Copyright Object corresponding to the changed Media Object from a Copyright Issuance server; and
a module, configured to install the changed Media Object and delete original Media Object and original Copyright Object.

15. The Terminal Equipment according to claim 14, further comprising:
a module, configured to merge the original Copyright Object and the new Copyright Object or to return the original Copyright Object, before deleting the original Copyright Object.

16. A terminal equipment, comprising:
a module, configured to determine that a plurality of Media Objects sharing one Copyright Object are changed and require to update all the changed Media Objects when updating one of original Media Objects;
a module, configured to obtain a new Copyright Object from a Copyright Issuance server and obtain all the changed Media Objects from a server; and
a module, configured to install all the changed Media Objects and delete the original Media Objects.

17. The Terminal Equipment according to claim 16, further comprising:
a module, configured to delete the original Copyright Object shared by the plurality of Media Objects.

18. The Terminal Equipment according to claim 17, further comprising:
a module, configured to merge the original Copyright Object and the new Copyright Object or return the original Copyright Object before deleting the original Copyright Object.
